(19) United States
(12) Patent Application Publication
(10) Pub. No.: US 2007/0144919 A1
(43) Pub. Date: Jun. 28, 2007

(54) Ion selective electrode

(76) Inventor: Kuang L. Cheng, Kansas City, MO (US)

Correspondence Address: Vista IP Law Group LLP, 2040 MAIN STREET, 9TH FLOOR, IRVINE, CA, 92614, US

(21) Appl. No.: 11/318,175

(22) Filed: Dec. 23, 2005

(51) Int. Cl. G01F 1/64; G01N 27/26

(52) U.S. Cl. 205/789; 204/416

(57) ABSTRACT

An ion selective electrode (ISE) includes an electrode body or housing having an ion selective membrane located at one end thereof and an indicator electrode formed at or adjacent to the ion selective membrane. A sealed vessel is disposed inside the electrode body, the sealed vessel holding an electrically conductive solution and a reference electrode conductor, wherein a portion of the reference electrode conductor is submerged in the electrically conductive solution. The ISE includes a conductive member having a proximal end and a distal end, wherein the proximal end of the conductive member terminates inside the sealed vessel and the distal end terminates outside the housing. The construction of the ISE keeps the reference electrode separate from the indicator electrode. Electrons are passed to the reference electrode via the conductive member obviating the need for a salt bridge. Importantly, no reference electrode is needed that connects to the inner membrane surface. The ISE operates on the double capacitor mechanism which is fundamentally different from the conventional Nernst redox reactions described in the prior art.

### FIELD OF THE INVENTION

The field of the invention generally relates to ion selective electrodes (ISEs). More specifically, the invention relates to an ion selective electrode in which the reference electrode of the ISE is not directly in contact with a sample solution.

### BACKGROUND OF THE INVENTION

ISEs are used to measure the concentration of charged species within a sample or test solution. One common use of an ISE is in pH meters, which use the ISE to determine the concentration of hydrogen or hydroxyl ions in a solution (and thus the pH of the solution). Conventional ISEs generally consist of a cylindrical tube between 5 and 15 mm in diameter and 5 to 10 cm long. An ion-selective membrane is fixed at one end of the tube so that the external solution can only come into contact with the outer surface of the ISE membrane, and the other end is fitted with a low noise cable or the like for connection to a voltage meter. Conventional ISEs use an indicator electrode and a reference electrode, both of which are immersed into the sample or test solution.

Many ISEs are made in the form of combination electrodes in which the reference electrode is housed in the same cylindrical body as the sensor head (e.g., indicator electrode). This design produces a relatively compact unit for immersing in the test solution and has the added advantage that the two electrodes are in close proximity (with the reference electrode normally coaxially surrounding the sensor element). A main disadvantage of this construction, however, is in certain cases, the sample solution causes the reference electrode potential to be unstable and that the reference electrode is the most likely to fail, well before the ISE indicator electrode. Unfortunately, the unitary construction requires that the entire unit has to be replaced when failure or problems arise. In addition, such an arrangement causes sometimes incorrect measurement results.

Another disadvantage of conventional ISEs relates to the fact that both the reference electrode and the indicator electrode are in contact with the sample solution. The reference electrode becomes contaminated over time by electrolytes within the sample solution. A salt bridge or double-junction reference electrode may be used to overcome this problem but the salt bridge increases the cost and undesirable results. In addition, the double-junction reference electrode introduces an extra interface between two electrolytes and thus provides the opportunity for an extra liquid junction potential to develop.

### SUMMARY OF THE INVENTION

In one aspect of the invention, an ion selective electrode (ISE) includes a housing having a proximal end and distal end, and an ion selective membrane located in the distal end of the housing. The ISE includes a first conductor having a proximal end and a distal end, at least a portion of the first conductor being disposed inside the housing with the distal end terminating at or adjacent to the ion selective membrane. A reference electrode is disposed inside the housing, the reference electrode including a sealed vessel holding an electrically conductive solution and a second conductor having a proximal end and a distal end, wherein the distal end terminates in the electrically conductive solution. The ISE includes a third conductor having a proximal end and a distal end, wherein the proximal end of the third conductor terminates inside the sealed vessel of the reference electrode and the distal end terminates outside the housing.

Alternatively, the reference electrode may be located outside the housing, for example, affixed or otherwise located near the upper part of the housing. In addition, the reference electrode may be formed as a solid state ISE.

In another embodiment, an ion selective electrode (ISE) includes an electrode body or housing having an ion selective membrane located at one end thereof and an indicator electrode formed at or adjacent to the ion selective membrane. A sealed vessel is disposed inside the electrode body, the sealed vessel holding an electrically conductive solution and a reference electrode conductor, wherein a portion of the reference electrode conductor is submerged in the electrically conductive solution. The ISE includes a conductive member having a proximal end and a distal end, wherein the proximal end of the conductive member terminates inside the sealed vessel and the distal end terminates outside the housing. The construction of the ISE keeps the reference electrode away separate from the indicator electrode. Electrons are passed to the reference electrode via the conductive member obviating the need for a salt bridge.

In still another embodiment, a method of measuring the concentration of an analyte is provided. The method includes the steps of providing an ion selective electrode having a housing containing an indicator electrode and a reference electrode, the reference electrode being contained inside a sealed vessel within the housing. A conductive member is also provided having a proximal end and a distal end, wherein the proximal end of the conductive member terminates inside the sealed vessel and the distal end terminates outside the housing. The indicator electrode and the reference electrode are coupled to a potentiometer. The indicator electrode and conductive member are then inserted into an analyte solution. The concentration of the analyte is then determined based on the potentiometer reading.

In conventional ISEs, the mechanism of operation is based on the Nernst redox reaction. In contrast, the present invention is based on the inventor's double capacitor mechanism.

### BRIEF DESCRIPTION OF THE DRAWINGS

FIG. 1 illustrates a cross-sectional view of an ISE according to one embodiment.

FIG. 1A illustrates a cross-sectional end view taken along the line A-A in FIG. 1.

FIG. 2 illustrates a cross-sectional view of an alternative ISE according to another embodiment.

FIG. 2A illustrates a cross-sectional end view taken along the line A-A in FIG. 2.

FIG. 3 illustrates a cross-sectional view of an alternative ISE according to another embodiment.

FIG. 3A illustrates a cross-sectional end view taken along the line A-A in FIG. 3.

FIG. 4 illustrates a cross-sectional view of an alternative ISE according to another embodiment.

FIG. 4A illustrates a cross-sectional end view taken along the line A-A in FIG. 4.

FIG. 5 illustrates a cross-sectional view of an alternative ISE according to another embodiment.

FIG. 6 illustrates a cross-sectional view of an alternative ISE according to another embodiment.

FIG. 6A illustrates a cross-sectional end view taken along the line A-A in FIG. 6.

### DETAILED DESCRIPTION OF THE PREFERRED EMBODIMENTS

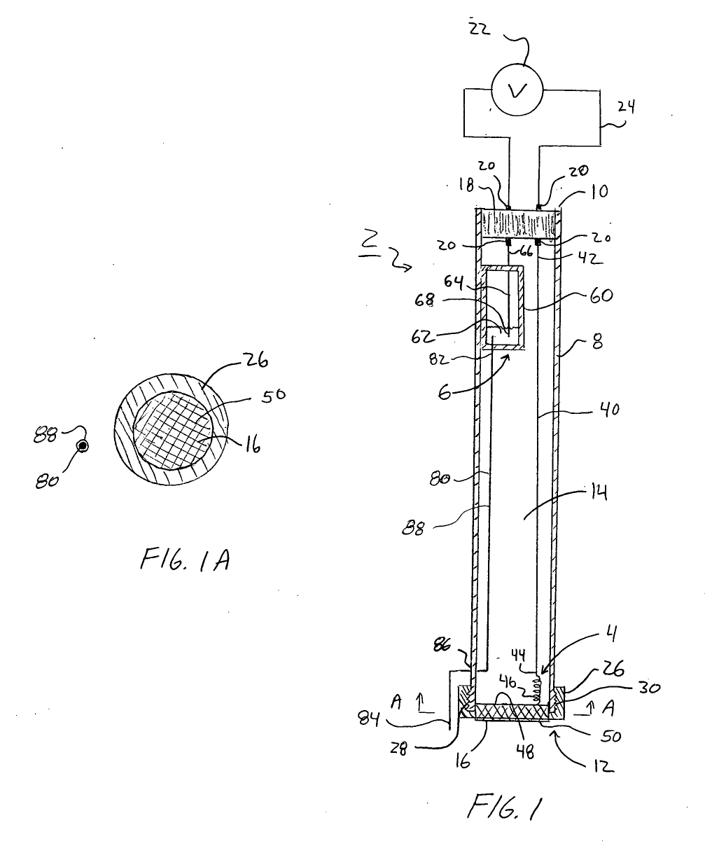

FIGS. 1, 1A, 2, 2A, 3, 3A, 4, 4A, and 5 illustrate an ion selective electrode (ISE) 2. The ion selective electrode 2 may be used to determine the concentration of one or more analytes or species contained within a sample solution. As just one example, the ISE 2 may be used to measure the concentration of hydrogen ions in a solution, which can then be used to determine the solution's pH. The ISE 2 includes two electrodes, an indicator electrode 4 and a reference electrode 6. As explained below, the reference electrode 6 is physically separated from the indicator electrode 4 and does not directly make contact with a sample solution.

As seen in FIGS. 1, 1A, 2, 2A, 3, 3A, 4, 4A, and 5 the ISE 2 includes a housing 8 or electrode body. The housing 8 may be formed from a non-conductive material such as, for example, plastic-based materials. The housing 8 generally includes a proximal end 10 and a distal end 12 and a lumen 14 passing there between. In one aspect of the ISE 2, the housing 8 contains both the indicator electrode 4 and the reference electrode 6. With reference to FIGS. 1 and 1A, an ion selective membrane 16 is located in at or near the distal end 12 of the housing 8. The ion selective membrane 16 is selective for certain chemical species or analytes (e.g., charged species such as ions). The ion selective membrane 16 may be formed from a solid crystal matrix. For instance, the crystalline matrix 16 may be formed from a single crystal or even a polycrystalline compressed pellet. Alternatively, the ion selective membrane 16 may be formed from a plastic or rubber film that is impregnated with a complex organic molecule which acts as an ion-carrier. The ion selective membrane 16 may have a diameter within the range of about 0.5 cm to about 2.0 cm although other sizes may be used. The ion selective membrane 16 is typically formed as thin as possible (e.g., about 0.1 mm in thickness).

The ion selective membrane 16 may be used to selectively adsorb one or more ionic species. Typical ionic species include, by way of illustration and not limitation, Ammonium (NH₄⁺), Barium (Ba⁺⁺), Calcium (Ca⁺⁺), Cadmium (Cd⁺⁺), Copper (Cu⁺⁺), Lead (Pb⁺⁺), Mercury (Hg⁺⁺), Potassium (K⁺), Sodium (Na⁺), Silver (Ag⁺) , Bromide (Br⁻) , Carbonate (CO₃²⁻), Chloride (Cl⁻), Cyanide (CN⁻), Fluoride (F⁻), Iodide (I⁻), Nitrate (NO₃⁻), Nitrite (NO₂⁻), Perchlorate (ClO₄⁻), Sulphide (S²⁻), and Thiocyanate (SCN⁻), etc. Importantly, the present invention operates on the double-capacitor theory to compare the indicator electrode 4 capacitance against the reference electrode 6 capacitance. The following publications describing the double-capacitor theory by the inventor are incorporated by references as if set forth fully herein: Cheng, K. L., pH Glass Electrode and its Mechanism, In Electrochemistry, Past and Present (J. T. Stock and M. V. Orna, Eds.), ACS Symposium Series 390, pp. 286-302 (1989), and K. L. Cheng, “Capacitor theory for nonfaradaic potentiometry” Microchem. J., 42, 5-24 (1990).

The proximal end 10 of the ISE 2 may be closed by use of a cap 18 or similar structure. The cap 18 may include one or more electrical contacts 20 for the various conductors (described in more detail below) of the indicator electrode 4 and a reference electrode 6. The electrical contacts 20 may pass through the entire cap 18 to permit electrical attachment of the ISE 2 to a potential meter 22 (e.g., potentiometer) via wires 24 or the like for measuring the potential difference between the indicator electrode 4 and the reference electrode 6.

Referring still to FIG. 1, in one embodiment, the ion selective membrane 16 is removable from the housing 8. For example, the ion selective membrane 16 may be retained or held within a removable cap 26. As best seen in FIGS. 1 and 1A, the removable cap 26 includes an interior receiving portion 28 that engages with corresponding threads 30 located on the distal end 12 of the housing 8. In this manner, the removable cap 26 (and associated ISE membrane 16) may be removed from the housing 8, for example, to replace or change the ion selective membrane 16 of the ISE 2.

As best seen in FIG. 1, located within the lumen 14 of the housing 8 is a first conductor 40 having a proximal end 42 and a distal end 44. The proximal end 42 of the first conductor 40 is in electrical contact with one of the electrical contacts 20 which, in turn, is in electrical contact with the potential meter 22. The distal end 44 of the first conductor 40 terminates at or adjacent to the ion selective membrane 16. In one embodiment, as seen in FIG. 1, the distal end 44 of the first conductor 40 terminates in a coiled or spring-shaped tip 46. The coiled tip 46 permits the distal end 44 of the first conductor 40 to contact the inner surface 48 of the ion selective membrane 16. In yet another embodiment, the ion selective membrane 16 may include a small conductive member (not shown) that engages with the distal end 44 of the first conductor 40. Alternatively, the distal end 44 of the first conductor 40 may be secured to the inner surface 48 using a conducting glue or other techniques known for making solid-state ISEs.

In addition, the inner surface 48 of the ion selective membrane 48 may be coated with a paint or other substance to decrease the effective surface area to alter the sensitivity of the ion selective membrane 48. For instance, the inner surface 48 may be partially coated with a non-conducting material to decrease its effective surface area for increasing the sensitivity of the ISE 2. This is accomplished by changing the ratio of the surface area of the inner surface 48 to the surface area of the outer surface 50 (S.A. inner surface 48/S.A. outer surface 50). By decreasing this ratio, the sensitivity of the ISE 2 is increased.

In an alternative embodiment, the distal end 44 of the first conductor 40 does not directly contact the inner surface 48 of the ion selective membrane 16. The electrical connection between the distal end 44 of the first conductor 40 and the inner surface 48 of the ion selective membrane 16 may be formed using a small amount of electrically conductive solution (not shown) located within the housing 8. The electrically conductive solution may include, for example, a salt-based solution.

Still referring to FIG. 1, the reference electrode 6 is provided inside the housing 8 and is physically separated from the indicator electrode 4. As best seen in FIG. 1, the reference electrode 6 includes a sealed vessel 60 or housing holding an electrically conductive solution 62. The electrically conductive solution 62 may include, for example, a pH buffer solution or a solution of KCl saturated with AgCl. Because AgCl is light sensitive, the sealed vessel 60 or housing may need to be formed from an opaque or colored material (or coated). The reference electrode 6 includes a second conductor 64 that includes a proximal end 66 and a distal end 68. The second conductor 64 may take the form of a wire or the like. The proximal end 66 is connected to an electrical contact 20 in the cap 18 which, in turn, is electrically connected to the potential meter 22. The distal end 68 of the second conductor 64 may comprise a silver wire coated with a layer of silver chloride (i.e., the distal end 68 is chloridized).

Alternatively, the reference electrode 6 may be located outside or external to the housing 8. For example, the reference electrode 6 may be positioned or located at or near the proximal 10 end of the housing. Also, instead of using an electrically conductive solution for the reference electrode 6, the reference electrode 6 may be formed as a solid state ISE.

Still referring to FIG. 1 and FIG. 1A, the reference electrode 6 includes a third conductor 80. The third conductor 80 includes a proximal end 82 and a distal end 84. As best seen in FIG. 1, at least a portion of the third conductor 80 is disposed inside the housing 8 of the ISE 2 with the proximal end 82 terminating inside the reference electrode 6. The proximal end 82 of the third conductor 80 is exposed to the electrically conductive solution 62 within the sealed vessel 60 of the ISE 2. The portion of the third conductor 80 near the proximal end 82 is fixed or sealed with the sealed vessel 60. The distal end 84 of the third conductor 80 terminates outside the housing 8 of the ISE 2. For example, as seen in FIGS. 1, 2, 3, and 4 the third conductor 80 may pass through a sealed opening or port 86 in the housing 8. In this regard, the distal end 84 of the third conductor 80 may be exposed to a test or sample solution in which the ISE 2 is placed.

At least a portion of the third conductor 80 is coated with in insulating material 88 such as, for example, an insulating polymer. The portion of the third conductor 80 exposed to the lumen 14 or interior of the housing 8 should be coated with the insulating material 88. In addition, a portion of the third conductor 80 that lies outside the housing 8 may be coated with the insulating material 88. However, at least a portion of the third conductor 80 lying outside the housing 8 should be free of any insulating material 88 such that the third conductor 80 can directly contact the sample or test solution. The third conductor 80 may be formed from an electrically conductive wire or the like (e.g., platinum, aluminum, or graphite).

The third conductor 80 thus acts as a conduit for passing electrons from the sample or test solution to the potential meter 22. The third conductor 80 thus replaces the salt bridge used in conventional ISEs. It is important to note that, as best as understood by the inventor, no redox reactions are involved in the operation of the ISE 2. Alternatively, the reference electrode 6 may be another ISE such as a pH electrode in a pH 5.0 buffer solution instead of commonly used Ag/AgCl.

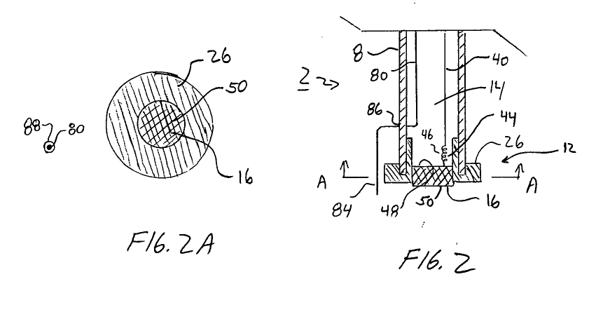

FIGS. 2 and 2A illustrate an alternative embodiment of the ISE 2. The ISE 2 in FIGS. 2 and 2A uses a cap 18 that forms a frictional fit within the housing 8. The cap 18 may be inserted into the housing 8 by simply pressing the cap 18 (and contained ISE membrane 16) toward the proximal end 10 of the housing 8. Conversely, the cap 18 may be removed by pulling the cap 18 distally away from the housing 8. Different caps 18 may contain different ion selective membranes 16. In this regard, there is no need to replace or change the entire ISE 2 when a new or different ion selective membrane 16 is needed. Instead, the user simply exchanges ion selective membranes 16 using the removable cap 18. Electrical contact between the distal end 44 of the first conductor 40 and the inner surface 48 of the ion selective membrane 16 may be accomplished via a coiled or spring-shaped tip 46 (as shown in FIG. 2) or by use of a small amount of conductive solution within the housing 8.

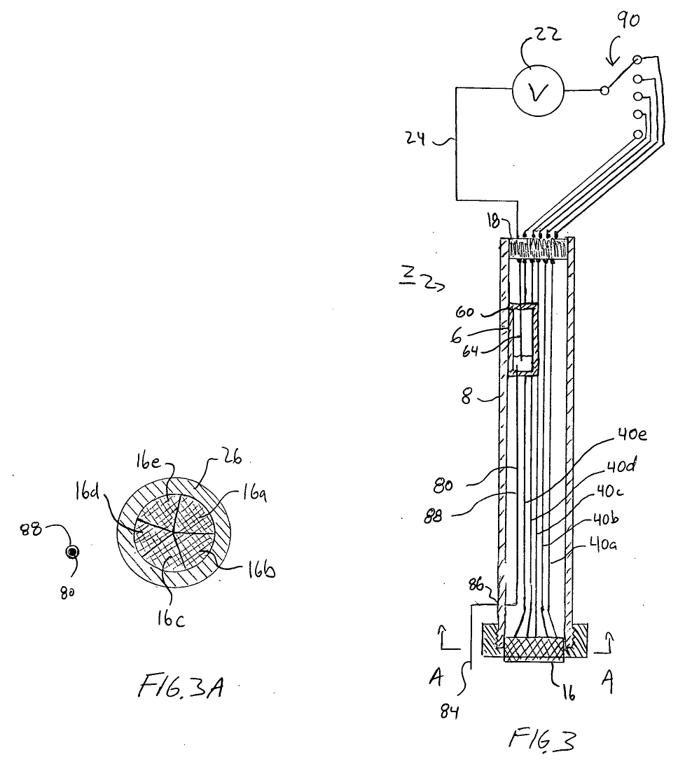

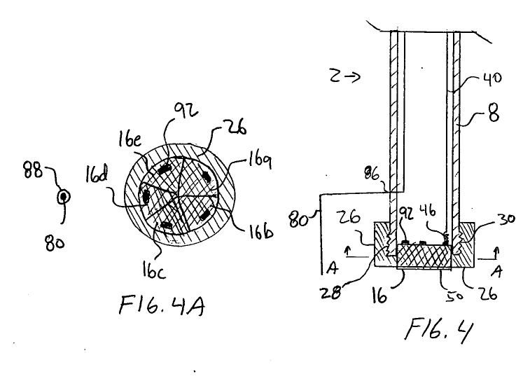

FIGS. 3, 3A, 4, and 4A illustrate additional alternative embodiments of a ISE 2. In the ISE 2 shown in FIGS. 3, 3A, 4, and 4A, the ion selective membrane 16 includes a plurality of separate or segregated membranes 16a, 16b, 16c, 16d, 16e (best seen in FIGS. 3A and 4A). Each separate membrane (e.g., 16a) may have a different sensitivity or selectivity than the remaining membranes in the cap 26. For example, a first membrane 16a may permit adsorption of a first analyte or chemical species while a second membrane 16b may permit adsorption of a second analyte or chemical species. Alternatively, each membrane 16a-e may adsorb the same analyte or chemical species but with different sensitivities.

In one aspect of this embodiment, the potential meter 22 is switchable between the different membranes 16a-e within the cap 26. With reference to FIG. 3, a plurality of conductors 40a, 40b, 40c, 40d, 40e are provided, with each conductor 40a-e being associated with a particular ion selective membrane 16a-e. A switch 90 is provided that is used to selectively engage the different ion selective membranes 16a-e with the potential meter 22. Each individual conductor 40a-e may be selected to activate the particular ISE membrane 16a-e. The switch 90 may be mounted on the housing 8, or separate from the ISE 2 (e.g., on the potential meter 22).

The cap 28 containing the plurality of ISE membranes 16a-e may be permanently affixed to the housing 8, or alternatively, the cap 28 may be removable from the proximal end 10 of the housing 8 as is described above.

FIGS. 4 and 4A illustrate yet another alternative embodiment in which a single conductor 40 is used to selectively engage with a particular ISE membrane 16a-e. A cap 26 containing the plurality of ISE membranes 16a-e is rotatable to selectively engage an inner membrane surface 48 with the distal tip 46 of the conductor. Each ISE membrane 16a-e may contain an optional electrical contact 92 or the like to selectively engage with the distal tip 46 of the conductor 40. The particular ISE membrane 16a-e is selected by rotating the cap 26 to bring the distal tip 46 into electrical contact with the selected ISE membrane 16a-e. It should be understood, however, that the electrical contact 92 may be omitted entirely. In this regard, the distal tip 46 of the conductor 40 would directly contact the inner surface 48 of the ISE membranes 16a-e (or indirectly through the use of a conductive solution or the like).

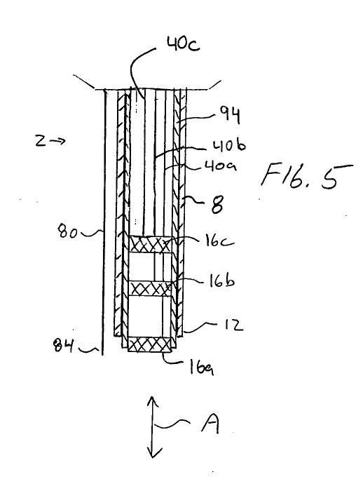

FIG. 5 illustrates another embodiment of an ISE 2 with multiple ISE membranes 16a, 16b, 16c. In this embodiment, the membranes 16a-16c are contained within a slidable housing 94 within the ISE 2. The slidable housing 94 can be moved in the proximal and/or distal directions (as shown by arrow A) to selectively position the desired ISE membrane 16a, 16b, 16c at the distal end 12 of the ISE housing or electrode body 8. The slidable housing 94 may be moved by pulling the housing 94 directly or through the use of some attachment member (not shown) to move the housing 94 (and ISE membranes 16a-16c) in the distal and/or proximal directions. Alternatively, a push member or the like (not shown) located in the ISE housing 8 may be used to advance and/or retract the slidable housing 94.

Still referring to FIG. 5, individual conductors 40a, 40b, 40c may be connected to the separate ISE membranes 16a, 16b, 16c. A switch 90 of the type shown in FIG. 3 may be used to selectively engage the individual conductors 40a, 40b, 40c to the potential meter 22 (not shown in FIG. 5). The slidable housing 94 may be permeable or include one or more openings to permit each ISE membrane 16a-16c to contact the sample solution.

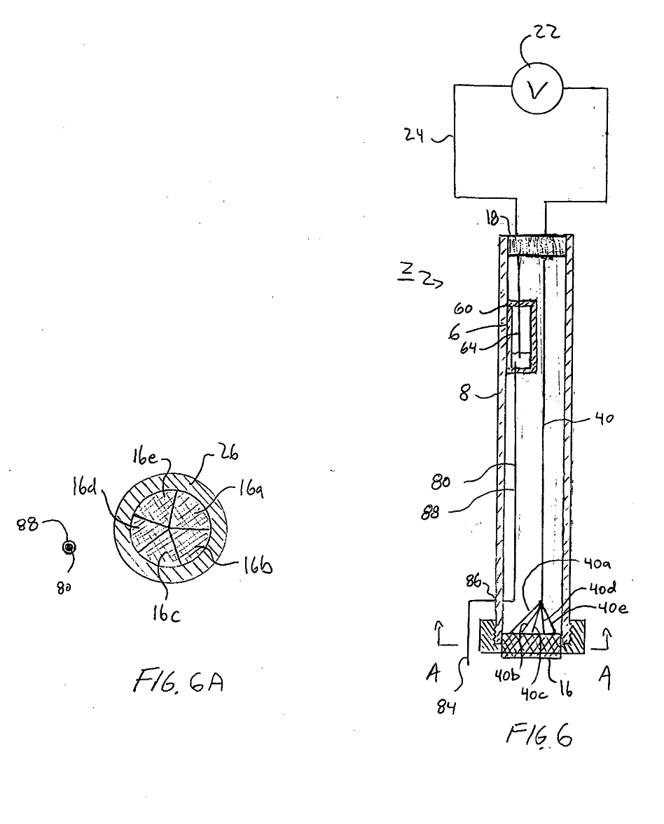

FIGS. 6 and 6A illustrates yet another embodiment of and ISE 2. In this embodiment, the sensitivity of the ion selective membrane 16 is amplified by using multiple membranes 16a-e connected in series (as best seen in FIG. 6A). As best seen in FIG. 6, a single conductor 40 terminates or is otherwise electrically connected to a plurality of terminal conductors (40a, 40b, 40c, 40d, 40e) that contact the individual membranes 16a-16e (as best seen in FIG. 6A). In this embodiment, the sensitivity of the ISE 2 is increased approximately five (5) times because the five separate membranes 16a-16e are connected together. Amplification is provided by connecting the various membranes in series (See, e.g., K. Cheng et al., Evidence of Adsorption of Hydrogen and Hydroxide Ions by pH-Sensitive Glass, and Chemical Potential Amplification, J. Chem. Soc., Chem. Commun., 1333 (1988) which is incorporated by reference as if set forth herein).

The ISE 2 described herein utilizes a construction that is less complex than prior art ISE devices. For example, there is no need for complicated salt bridge structures in the ISE 2 described herein. The salt bridge is replaced by the reference electrode conductor 80. Similarly, by placing the reference electrode 6 within the housing 8 of the ISE 2, the reference electrode 6 is maintained in a stable condition and is not affected by the sample solution. There is no additional Ag/AgCl reference electrode connected to the inner surface 48 of the membrane 16 as commonly used in conventional ISEs.

To measure the concentration of an analyte within a sample solution, the ISE 2 of the type described herein is attached to a potentiometer 22. The indicator electrode 4 and reference electrode 6 are thus connected to opposing leads or ends of the potentiometer 22. The ISE 2 is then inserted into the test or sample solution such that the ion selective membrane 16 and the reference electrode conductor 80 are exposed to the test or sample solution. The concentration of the analyte of interest may then be determined from the ISE 2 based on the reading from the potentiometer 22 as in conventional ISEs.

While embodiments of the present invention have been shown and described, various modifications may be made without departing from the scope of the present invention. The invention, therefore, should not be limited, except to the following claims, and their equivalents.

1. An ion measurement electrode comprising:
a housing having a proximal end and distal end;
an ion membrane located in the distal end of the housing;
a first conductor having a proximal end and a distal end, at least a portion of the first conductor being disposed inside the housing with the distal end terminating at or adjacent to the ion membrane;
a reference electrode disposed inside the housing, the reference electrode comprising a sealed vessel holding an electrically conductive solution, the reference electrode including a second conductor having a proximal end and a distal end, the distal end terminating in the electrically conductive solution; and
a third conductor having a proximal end and a distal end, wherein the proximal end of the third conductor terminates inside the sealed vessel of the reference electrode and the distal end passes through a sealed port in the housing and terminates outside the housing, the third conductor being coated with an insulating material on a portion thereof contained in the housing leaving both the proximal and distal ends exposed.

2. The device of claim 1, further comprising a potential meter connected to the proximal end of the first conductor and the proximal end of the second conductor.

3. The device of claim 1, wherein the ion membrane is removable from the housing.

4. The device of claim 3, wherein the ion membrane is contained in a removable cap.

5. The device of claim 1, wherein the housing contains an electrically conductive solution.

6. (canceled)

7. The device of claim 1, wherein the third conductor comprises a wire.

8. The device of claim 1, wherein the second conductor comprises a silver wire coated with a layer of silver chloride.

9. The device of claim 1, wherein the ion membrane comprises a plurality of separate ion membranes contained in a single cap each having an electrical contact for electrical coupling with the distal end of the first conductor, and wherein the cap is rotatable.

10. (canceled)

11. An ion selective electrode comprising:
an electrode body having an ion membrane located at one end thereof and an indicator electrode formed at or adjacent to the ion membrane, the ion membrane having an inner surface exposed to the electrode body and an outer surface exposed for measurement, wherein a portion of the inner surface of the ion membrane is coated with an electrically non-conductive material;
a sealed vessel disposed inside the electrode body, the sealed vessel holding an electrically conductive solution and a reference electrode conductor, wherein a portion of the reference electrode conductor is submerged in the electrically conductive solution; and
a conductive member having a proximal end and a distal end, wherein the proximal end of the conductive member terminates inside the sealed vessel and the distal end terminates outside the housing, the conductive member being coated with an insulating material on a portion thereof contained in the housing leaving both the proximal end and distal end exposed.

12. The device of claim 11, further comprising a potential meter connected to the indicator electrode and the reference electrode conductor.

13. The device of claim 11, wherein the ion membrane is removable from the electrode body.

14. The device of claim 13, wherein the ion membrane is contained in a removable cap.

15. (canceled)

16. The device of claim 11, wherein the conductive member comprises a wire.

17. The device of claim 11, wherein the ion membrane comprises a plurality of separate ion membranes contained in a single cap.

18. The device of claim 17, wherein the cap is rotatable to selectively switch each ion membrane.

19. A method of measuring the concentration of an analyte comprising:
providing an ion measurement electrode having a housing containing an indicator electrode and a reference electrode, the reference electrode being contained inside a sealed vessel within the housing;
providing a conductive member having a proximal end and a distal end, wherein the proximal end of the conductive member terminates inside the sealed vessel and the distal end terminates outside the housing via a sealed port, the conductive member being electrically insulated within the housing and having the proximal end and distal end exposed;
coupling the indicator electrode and the reference electrode to a potentiometer;
inserting the indicator electrode and conductive member in an analyte solution; and
determining the concentration of the analyte based on the potentiometer reading.

20. The method of claim 19, wherein the indicator electrode comprises a plurality of switchable indicator electrodes contained in a single cap, the method further including the step of selecting one of said indicator electrodes by rotating the cap.
